(19) United States
(12) Patent Application Publication
(10) Pub. No.: US 2008/0223128 A1
(43) Pub. Date: Sep. 18, 2008

(54) Capacitive Gauge Comprising Interdigital Electrodes On An Insulating Substrate

(75) Inventor: Volodia Naydenov, Louvain-La-Neuve (BE)

Correspondence Address: Solvay North America, LLC;c/o Kim Manson, Esq., 4500 McGinnis Ferry Road, Alpharetta, GA, 30005, US

(73) Assignee: Inergy Automotive Systems Research, Brussels (BE)

(21) Appl. No.: 12/091,066

(22) PCT Filed: Oct. 17, 2006
(86) PCT No.: PCT/EP2006/067503

§ 371 Date: Apr. 22, 2008

(30) Foreign Application Priority Data
Oct. 26, 2005 (FR) 0510930
Oct. 26, 2005 (FR) 0510934

(51) Int. Cl. G01F 23/26; H01G 9/048

(52) U.S. Cl. 73/304 C; 361/284; 29/25.03

(57) ABSTRACT

Capacitive gauge comprising interdigital electrodes on an insulating substrate having the form of a hollow cylinder having an internal surface and an external surface, the interdigital electrodes being disposed on the internal surface of this cylinder.

The present invention relates to a capacitive gauge comprising interdigital electrodes on an insulating substrate, a method for manufacturing such a gauge and its use as a level gauge in fuel tanks.

Many devices have been proposed to date for measuring the level of liquid in the tanks, and in particular, in the fuel tanks of motor vehicles. These known devices normally use level sensors or gauges delivering a signal representative of the level of fuel in the tank.

In a variant, these level sensors or gauges comprise an electrical capacitor used for measurement and an electrical capacitor used for reference. The capacitor used for measurement is normally present over the entire height of the tank, and its capacitance varies according to the height of fuel in the tank. The capacitor used for reference is permanently immersed in the fuel and supplies a reference value of the dielectric constant of the fuel. An appropriate electronic circuit determines the level of the fuel in the tank. The capacitors of these sensors can be flat or cylindrical plates between which the fuel can fall and rise and influence the capacitance by skin effect. Alternatively, they can be interdigital (engaged comblike) electrodes which interact by interference effect; the latter are affixed to a substrate and look like printed circuits. Such electrodes can moreover be manufactured by manufacturing methods similar to those of printed circuits.

Thus, U.S. Pat. No. 4,296,630 discloses both capacitive gauges with interference effect comprising interdigital electrodes obtained by eroding a metallic layer affixed to a ribbon-shaped flat and flexible substrate, and capacitive gauges with skin effect in the form of cables obtained by overmoulding electrodes disposed in an annular fashion in an extrusion process. The first variant has the drawback of a low active surface and the need for a protective casing, particularly to avoid the effect of the waves. The second variant is difficult to produce in practice, and moreover its production is not explained in the patent concerned.

The present application seeks to resolve these problems by providing a capacitive gauge with large active surface, not requiring a protective casing (in particular, hydraulic protection against waves) and being easy to produce in practice.

To this end, the present invention relates to a capacitive gauge comprising interdigital electrodes on an insulating substrate having the form of a hollow cylinder having an internal surface and an external surface, the interdigital electrodes being disposed on the internal surface of this cylinder.

The term “gauge” is used to denote a device that supplies a signal representative of a liquid level in a tank. This device can include an electronic circuit for processing this signal, making it possible to determine the level and quantity of fuel in the tank. Alternatively, it can be linked to such a circuit. The use of an integrated circuit is advantageous, particularly because of the similarity in manufacturing processes mentioned previously.

Regarding the electrical connections between the electrodes and the electronic signal processing circuit, these are preferably covered by the insulating substrate so as not to disturb the measurement.

The term “interdigital” electrodes is used to denote electrodes having the form of coils with loops in the form of digits engaged comblike with each other, and this as described in the abovementioned U.S. patent. Preferably, these digits extend vertically, along internal generatrices of the cylinder. The fact of having the gauge positioned vertically in the tank makes it then possible to obtain a substantially linear signal according to the level of liquid to be measured.

Advantageously, and as described in the abovementioned U.S. patent, the gauge according to the invention can comprise a pair of interdigital measurement electrodes and a pair of reference electrodes, also interdigital. The latter is preferably located at one end of the substrate, which will be placed/fixed on the bottom of the tank (preferably, even, in a spare tank, if appropriate) so as to ensure its constant immersion in the liquid present in the tank. It makes it possible to disregard variations of temperature, pressure, nature of the liquid, and other interference factors likely to disturb the measurement. The relative cylinder height that it occupies is preferably small relative to that occupied by the pair of measurement electrodes, so that the latter can be present over substantially the entire height of the liquid. Preferably, the loops of the measurement electrode and of the reference electrode are both vertical. Furthermore, they advantageously have at least a part of an electrode in common.

According to the invention, the interdigital electrodes are present on a cylindrical insulating substrate. This substrate can be based on any known insulating material used as a printed circuit substrate, for example based on an insulating polymer chosen from the polyimides (such as the resins known by the trade name Capton®), epoxy resins and polyesters. This cylinder can be continuous or discontinuous along a generatrix. In particular, it can be obtained by welding, bonding etc. a flat insulating substrate.

According to an advantageous variant, the cylindrical substrate comprises, on its external surface, a conductive coating, for example metallic, acting as an electrostatic protection screen. A copper-based coating, with a thickness of 35 to 70 μm, is ideal.

The height of the cylindrical substrate is normally dependent on the maximum height of liquid in the tank. Its diameter is normally a trade-off between a good measurement accuracy and an acceptable size.

The present invention also relates to a method for manufacturing a gauge as described above. This method consists in manufacturing a flat gauge by any known method (such as erosion, photolithography, etc) and then winding the latter with electrodes turned inwards so as to form a cylinder.

In this method, preference is given to the use of a flexible substrate, that is a substrate made of a material and having a thickness enabling it to be wound. To this end, a substrate based on an insulating polymer as described previously is ideal.

The cylindrical form can be preserved by joining the two ends of the substrate by welding, bonding, etc, and/or by inserting the wound substrate into a plate of appropriate shape (metallic rings, for example).

Finally, the invention also relates to the use of a gauge as described previously as a level gauge in a fuel tank.

1. A capacitive gauge comprising interdigital electrodes on an insulating substrate, wherein the insulating substrate has the form of a hollow cylinder having an internal surface and an external surface and wherein the interdigital electrodes are disposed on the internal surface of the cylinder.

2. The gauge according to claim 1, wherein it transmits a signal representative of a liquid level in a tank wherein it incorporates an electronic circuit for processing said signal.

3. The gauge according to claim 2, wherein the electrical connections between the electrodes and the electronic signal processing circuit are covered by the insulating substrate so as not to disturb the measurement.

4. The gauge according to claim 1, wherein the electrodes have the form of coils with loops in the form of digits engaged comblike with each other and wherein these digits extend vertically, along internal generatrices of the cylinder.

5. The gauge according to claim 4, wherein it comprises a pair of measurement electrodes and a pair of reference electrodes, both interdigital with vertical digits, the latter being located at one end of the cylinder and occupying a small height of the latter, and the former extending over substantially the entire height of the cylinder.

6. The gauge according to the claim 5, wherein the pair of measurement electrodes and the pair of reference electrodes have a part of an electrode in common.

7. The gauge according to claim 1, wherein the cylinder comprises, on its external surface, a conductive coating acting as an electrostatic protection screen.

8. A method of manufacturing a gauge according to claim 1, according to which a capacitive gauge is manufactured comprising interdigital electrodes on a flat insulating substrate, and said gauge is wound with electrodes turned inwards so as to form a cylinder.

9. The method according to claim 8, wherein the cylindrical form of the gauge is preserved by welding, bonding and/or the use of a plate of appropriate shape.

10. A use of a gauge according to claim 1, or obtained by a method according to claim 9, as a level gauge in a fuel tank.
